(19) United States
(12) Patent Application Publication
(10) Pub. No.: US 2013/0228396 A1
(43) Pub. Date: Sep. 5, 2013

(54) Sheet Material Handling Device

(71) Applicant: Paul Cummings, Bicester (GB)

(72) Inventor: Paul Cummings, Bicester (GB)

(73) Assignee: Blue Sky Solutions Limited

(21) Appl. No.: 13/822,343

(22) PCT Filed: Sep. 21, 2011
(86) PCT No.: PCT/GB2011/001373

§ 371 Date: May 16, 2013

(30) Foreign Application Priority Data
Sep. 28, 2010 (GB) 1016255.0

(51) Int. Cl. B66C 1/10; B66F 11/04

(52) U.S. Cl. CPC B66C 1/10; B66F 11/044
USPC 182/129; 294/67.1

(57) ABSTRACT

A panel carrier assembly (30) for use with an aerial lift (10) and comprising a pair of spaced apart planar lattice frames (31,32), preferably rectangular, secured together in alignment one with the other by spacers (34) arranged around sides of the frame leaving one side free of obstructions to facilitate the insertion of sheets or panels P of material between the two frames (31,32), one of said frames (31) having bracket assemblies (48,49) thereon for securing to a lift.

### CROSS-REFERENCE TO RELATED PATENT APPLICATIONS

This application is a national stage of PCT Application No. PCT/GB2011/001373, filed Sep. 21, 2011, which claims priority to United Kingdom Priority Application 1016255.0 filed Sep. 28, 2010. The specification, drawings, claims and abstract of these applications are incorporated herein by reference in their entirety.

### FIELD

This invention relates to a sheet material handling device or carrier in particular but not necessarily for the moving lengths of roofing and facia materials used during construction of buildings.

### BACKGROUND OF THE INVENTION

Building construction sites for large buildings frequently employ construction equipment for lifting large and heavy components into position during the construction of a building. Facia panels for finishing off the edges of roofs may be in the order of 3000 mm in length, 650 mm in and up to 50 mm in thickness. Such sheets of material are unwieldy to handle and can only be lifted into work locations high above the ground by cranes and then may need to manhandled to the actual fitting site.

Aerial lifts are also used on sites for moving men and some materials to work locations high above the ground. A typical aerial lift may comprise a mobile self drive vehicle having an extendable boom which has an elevator basket or cage for housing operatives secured to the end of the boom. The basket may contain a control panel which permits an operator standing in the basket or cage to manoeuvre the basket or cage to a raised location which facilitates the carrying out of work. The boom is typically raised by a powered hydraulic system on the vehicle.

It is known for the operators of such lifts to carry materials in or on the cage, by for example tying or lashing materials to the structure of the cage. For safety, the work platform is surrounded by a safety barrier or fence for the protection of personnel on the platform. It is therefore not convenient or safe to place large sheets of material within the lift with the operator. This may give rise to dangerous situations, for example, if the sheet material obstructed the operator at the controls.

The present invention provides a means whereby an aerial lift may be utilised to move such large sheets of material to a work location.

### Statements of Invention

According to a first aspect of the present invention there is provided panel carrier assembly for use with an aerial lift and comprising a pair of spaced apart planar lattice frames secured together in alignment one with the other by spacers arranged around sides of the frame, one of said frames having brackets thereon for securing to a lift.

Preferably the lattice frames are rectangular in shape. The term rectangular includes square.

The spacers are arranged around the two shorter sides and one of the longer sides of the frames leaving one longer side free of obstructions so that sheets of material can be posted between the two frames.

The lattice frame is formed from tubular or box section struts and may be broken into smaller areas by cross-members and diagonal struts.

According to a second aspect of the invention there is provided an aerial lift having a work platform and a carrier as described above is attached via the brackets to the work platform.

Preferably the carrier is attached to the underside of the platform floor.

### DESCRIPTION OF THE DRAWINGS

The invention will be described by way of example and with reference to the accompanying drawings in which:

FIG. 1 is a side elevation of an aerial lift and platform with a carrier mounted in situ thereon.

FIG. 2 is an isometric view of the work station of an aerial lift with a material carrier according to the present invention,

FIG. 3 is an isometric view of a material carrier according to the present invention,

FIG. 4 is a plan view of the carrier shown in FIG. 3,

FIG. 5 is a side view of the carrier shown in FIGS. 3, and

FIG. 6 is an enlarged detail showing the brackets on the carrier.

### DETAILED DESCRIPTION OF THE INVENTION

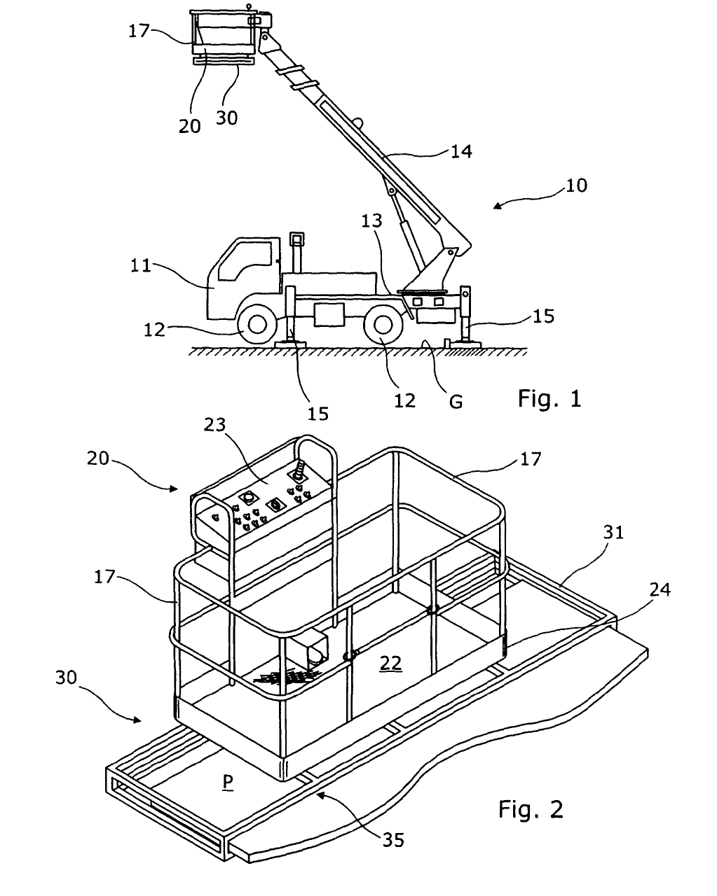

With reference to FIG. 1 of the drawings, there is shown a vehicle 10 in the form of a self drive mobile lift of any suitable type. The vehicle 10 has a drivable vehicle body 11 having wheels 12 and an extendable boom 14 mounted on a load carrying platform 13 at the rear of the vehicle. Stabilisers 15 are provided for steadying the vehicle on the ground G. A basket, cage or work platform 20 is mounted on the free end of the boom 14 and the basket, in use, can be raised or lowered and generally manoeuvred relative to the ground as is well known. The basket 20 is shown in a raised condition. The boom 14 is raised, lowered, extended, rotated etc. by any suitable means, typically operated by a powered hydraulic system provided on the vehicle 10.

The cage 20 has a platform floor 22 which is surrounded by a safety barrier 17 with a kick plate 24 adjacent the floor 22. The aerial lift may be controlled and operated via controls 23 by personnel working within the cage 20.

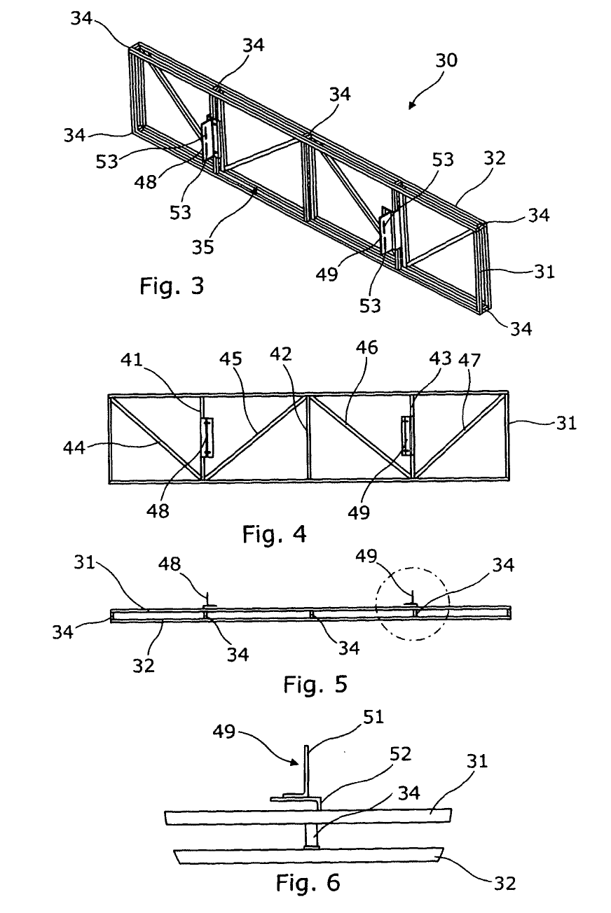

With reference also to FIGS. 2 to 6, there is shown a sheet material or panel carrier preferably mounted on the underside of the platform floor 22. Alternatively the carrier may be secured to the cage 20 at other suitable locations.

The panel carrier assembly 30 comprises at least two spaced apart lattice frames 31, 32 which are rectangular in shape. The frames are secured in alignment one with the other by spacers 34. The spacers 34 are arranged between the two shorter sides of the frames and one of the longer sides leaving one of the longer sides 35 open to receive a sheet or panel P of material e.g. a facia board, sheet of plywood, plaster board etc. pushed into the assembly 30.

The two frames 31, 32 are formed from tubular and/or box section aluminium struts which are welded together to form a lattice having cross-members 41-43 and diagonal struts 44-47. The two frames in this particular example are about 3200 mm in length and 650 mm in width and are spaced apart by about 50 mm. Other sizes of frame may be utilised to suit the sheet materials to be moved. One of the frames 31 has a pair of bracket assemblies 48, 49 secured to the cross-members 41, 42 respectively. The two bracket assemblies each comprise a pair of back to back “L” shaped brackets 51, 52. Each upper bracket 51 has elongate apertures 53 in its back whereby it is adjustably mounted to the underside of the platform floor 22 using suitable fasteners.

Both of said frames 31, 32 may be provided with diagonal struts 44-47. Alternatively, and as shown, only the frame 32, which in use is the lower frame, is provided with the diagonal struts. As well as stiffening the frame, the diagonal struts 44-47 also support at him sheet materials loaded within the carrier 21.

Typically the lift is intended for moving large rectangular sheets of material as described above. Once the sheet(s) or panel(s) P have been fully inserted into the carrier they may be secured in place and prevented from sliding out of the frame by straps, or webbing or other suitable means. When the operator within the aerial lift has manoeuvred the cage 20 and carrier 30 into its desired location, the sheet P is removed from the carrier by other workers already in position at the place of delivery.

1. A panel carrier assembly for use with an aerial lift and comprising a pair of spaced apart planar lattice frames secured together in alignment one with the other by spacers arranged around sides of the frame, one of said frames having brackets thereon for securing to an aerial lift.

2. A panel carrier assembly as claimed in claim 1, wherein the lattice frames are rectangular in shape.

3. A panel carrier assembly as claimed in claim 2 wherein the spacers are arranged around the two shorter sides and one of the longer sides of the frames leaving one longer side free of obstructions to facilitate the insertion of sheets of material between the two frames.

4. A panel carrier assembly as claimed in claims 1, wherein at least one of the lattice frames is formed from tubular struts and is divided into smaller areas by cross-members and diagonal struts.

5. A panel carrier assembly as claimed in claim 4, wherein the brackets are mounted on the cross-members of said one frame.

6. (canceled)

7. (canceled)

8. A panel carrier assembly as claimed in claim 4, wherein both of the lattice frames are formed from tubular struts and are divided into smaller areas by cross-members and diagonal struts.

9. A panel carrier assembly as claimed in claim 1, wherein at least one of the lattice frames is formed from box section struts and is divided into smaller areas by cross-members and diagonal struts.

10. A panel carrier assembly as claimed in claim 9, wherein the brackets are mounted on the cross-members of said one frame.

11. A panel carrier assembly as claimed in claim 9, wherein both of the lattice frames are formed from box section struts and are divided into smaller areas by cross-members and diagonal struts.

12. An aerial lift having a work platform, with a panel carrier assembly as claimed in claim 1 is attached via the brackets to the work platform.

13. An aerial lift as claimed in claim 12, wherein the panel carrier assembly is attached to the underside of the work platform floor.

14. An aerial lift as claimed in claim 13, wherein the panel carrier assembly is adjustably attached to the underside of the work platform floor by the brackets.

15. An aerial lift as claimed in claim 13, wherein the work platform is mounted at one end of an extendable boom.

16. An aerial lift as claimed in claim 15, wherein the extendable boom is mounted on a vehicle provided with a hydraulic powered system for operating the extendable boom.

17. An aerial lift as claimed in claim 15, wherein the aerial lift comprises a control panel which permits an operator standing on the work platform to manoeuvre the work platform to a desired location.
